(19) United States
(12) Patent Application Publication
(10) Pub. No.: US 2019/0205871 A1
(43) Pub. Date: Jul. 4, 2019

(54) SYSTEM AND METHODS FOR POPULATING A MERCHANT ADVICE CODE

(71) Applicant: Mastercard International Incorporated, Purchase, NY (US)

(72) Inventors: Christopher Vernon, Cottleville, MO (US); Kyle Williams, Wentzville, MO (US); David J. Senci, Troy, IL (US)

(73) Assignee: Mastercard International Incorporated, Purchase, NY (US)

(21) Appl. No.: 15/861,788

(22) Filed: Jan. 4, 2018

(51) Int. Cl. G06Q 20/38; G06Q 20/40; G06Q 20/28; G06Q 20/10; G06Q 20/34

(52) U.S. Cl. CPC G06Q 20/3821; G06Q 20/405; G06Q 20/351; G06Q 20/102; G06Q 20/28

(57) ABSTRACT

A merchant advice code system and computer-implemented method for populating a merchant advice code in a payment authorization response message includes a memory device for storing data and a processor communicatively coupled to the memory device. The processor is programmed to receive a payment authorization request message including a primary account number relating to the payment account of a cardholder. The processor is programmed to extract a copy of the primary account number from the payment authorization request message and determine whether the primary account number exists in an automated billing service database. In response to determining that the primary account number exists in the automated billing service database, the processor is programmed to store an indicator in the memory device and populate the merchant advice code in the payment authorization response message with the indicator, thereby generating an edited payment authorization response message.

### FIELD OF THE DISCLOSURE

The field of the disclosure relates generally to systems and methods for populating merchant advice codes and, more particularly, to systems and methods for an automated process to populate a merchant advice code with an indicator that new and/or updated account information exists for a payment transaction.

### BACKGROUND OF THE DISCLOSURE

Card-not-present transactions, such as online payment and/or recurring payments are common in the marketplace. In an online payment scenario, a cardholder preauthorizes a merchant to automatically bill a payment card for a purchase. In some cases, the merchant may store the cardholder's payment card information for future transactions. In addition, in a recurring payment scenario, a cardholder preauthorizes a merchant to automatically bill a payment card at a preset interval. Recurring payments are typically done for a matter of convenience for both the cardholder and the merchant. Online and recurring payment transactions typically occur without incident.

However, changes in the cardholder's account information, such as updated expirations dates and/or new account numbers can introduce challenges into the process. Often, the cardholder may not interact directly with the merchant during a transaction, or fail to update his/her account information in a stored scenario. When the merchant attempts to process a transaction, the transaction may be declined without a reason being providing by the payment card issuer. While the payment authorization response message includes data fields for providing merchants with advice codes as to why the transaction was declined, these fields are often left empty. If a merchant was aware that new account information was available, the merchant could better serve the cardholder by requesting from the cardholder and/or the payment network, the updated account information.

### BRIEF DESCRIPTION OF THE DISCLOSURE

This summary is not intended to identify essential features of the present invention, and is not intended to be used to limit the scope of the claims. These and other aspects of the present invention are described below in greater detail.

In one aspect, a merchant advice code system is provided. The merchant advice code system is configured for populating a merchant advice code in a payment authorization response message of a payment transaction. The merchant advice code system includes a memory device for storing data and a processor communicatively coupled to the memory device. The processor is programmed to receive a payment authorization request message including a primary account number relating to the payment account of a cardholder. In addition, the processor is programmed to extract a copy of the primary account number from the payment authorization request message, and to determine whether the primary account number exists in an automated billing service database. Furthermore, in response to determining that the primary account number exists in the automated billing service database, the processor is programmed to store an indicator in the memory device, and to populate the merchant advice code in the payment authorization response message with the indicator, thereby generating an edited payment authorization response message.

In another aspect, a computer-implemented method for populating a merchant advice code in a payment authorization response message is provided. The method includes receiving a payment authorization request message including a primary account number relating to the payment account of a cardholder. The method also includes extracting a copy of the primary account number from the payment authorization request message, and determining whether that the primary account number exists in an automated billing service database. Moreover, the method includes, in response to determining that the primary account number exists in the automated billing service database, storing an indicator in a memory device. In addition, the method includes populating the merchant advice code in the payment authorization response message with the indicator, thereby generating an edited payment authorization response message.

In yet another aspect, one or more non-transitory computer-readable storage media having computer-executable instructions embodied thereon is provided. When executed by at least one processor, the computer-executable instructions cause the processor to receive a payment authorization response message including a primary account number relating to the payment account of a cardholder. In addition, the executable instructions cause the processor to extract a copy of the primary account number from the payment authorization request message, and to determine whether that the primary account number exists in an automated billing service database. In response to determining that the primary account number exists in the automated billing service database, the executable instructions cause the processor to store an indicator in the memory device. Moreover, the executable instructions cause the processor to populate a merchant advice code in a payment authorization response message with the indicator, generating an edited payment authorization response message.

### BRIEF DESCRIPTION OF THE DRAWINGS

Embodiments of the present invention are described in detail below with reference to the attached drawing figures, wherein:

FIG. 1 is a block diagram of an example multi-party payment card network system having a merchant advice code (MAC) module;

FIG. 2 is a simplified block diagram of an example transaction processing system (TPS) for providing an indicator using the MAC module to merchants and/or merchant acquirers in a payment network;

FIG. 3 is an example configuration of a user system operated by a user, such as a cardholder of the multi-party payment card network system shown in FIG. 1;

FIG. 4 is an example configuration of a server system, such as a server system for use in the system shown in FIG. 2;

FIG. 5 is a schematic diagram of the payment card network system shown in FIG. 1, showing data flow among the parties during a payment transaction; and

FIG. 6 is a flow chart of an example method for populating a merchant advice code in a payment authorization response message.

The figures are not intended to limit the present invention to the specific embodiments they depict. The drawings are not necessarily to scale. Like numbers in the Figures indicate the same or functionally similar components.

### DETAILED DESCRIPTION OF THE DISCLOSURE

The following detailed description of embodiments of the invention references the accompanying figures. The embodiments are intended to describe aspects of the invention in sufficient detail to enable those with ordinary skill in the art to practice the invention. The embodiments of the invention are illustrated by way of example and not by way of limitation. Other embodiments may be utilized and changes may be made without departing from the scope of the claims. The following description is, therefore, not limiting. It is contemplated that the invention has general application to identifying and verifying entities requesting access to confidential information and/or financial services. The scope of the present invention is defined only by the appended claims, along with the full scope of equivalents to which such claims are entitled.

In this description, references to “one embodiment,” “an embodiment,” or “embodiments” mean that the feature or features referred to are included in at least one embodiment of the invention. Separate references to “one embodiment,” “an embodiment,” or “embodiments” in this description do not necessarily refer to the same embodiment and are not mutually exclusive unless so stated. Specifically, a feature, component, action, step, etc. described in one embodiment may also be included in other embodiments, but is not necessarily included. Thus, particular implementations of the present invention can include a variety of combinations and/or integrations of the embodiments described herein.

Broadly characterized, the present invention relates to systems and methods for populating a merchant advice code in a payment authorization response message. More particularly, the disclosed embodiments provide a system and computer-implemented method for automating a process to identify new and/or updated account information for a consumer's payment card account, and populate a merchant advice code to inform a merchant that new and/or updated information exists. In one example embodiment, a merchant advice code (MAC) system (or module) is configured for use with a payment card processing network such as, for example, an interchange network. The MAC module includes a memory device and a processor in communication with the memory device and is programmed to communicate with the interchange network to receive payment authorization request messages from merchants processing payment transactions. The MAC module extracts the primary account number (PAN) from the authorization message and checks it against an automated billing updater (ABU) service to see if new or updated account information is available for the PAN. If new information is available and the issuer does not populate the MAC in the payment authorization response message, the MAC module may populate the MAC to facilitate informing the merchant why the transaction was declined.

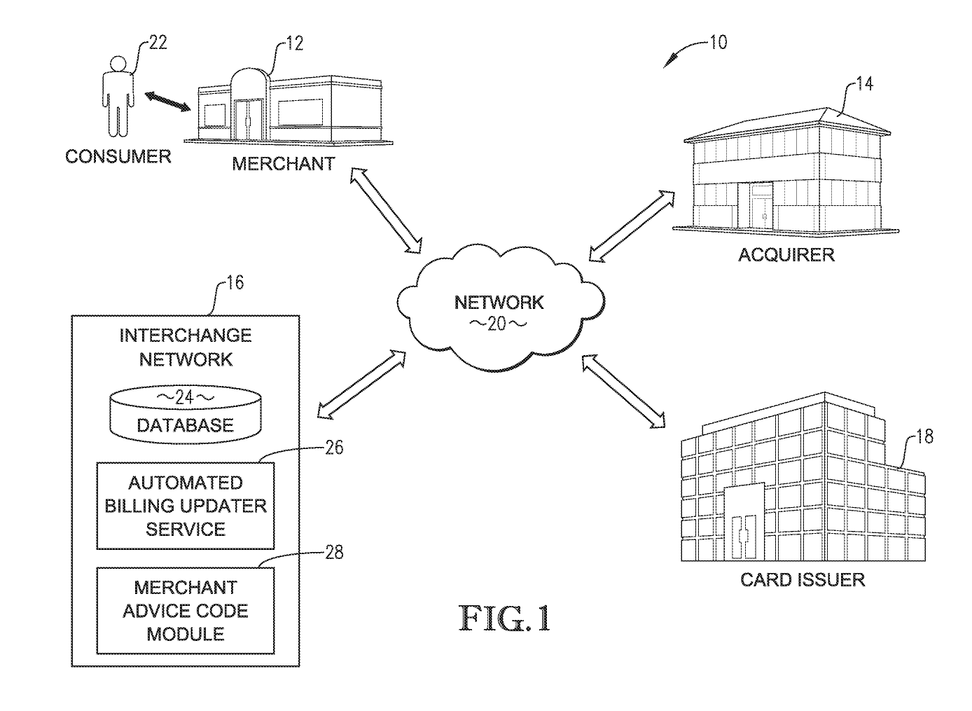

FIG. 1 is a block diagram of an example multi-party payment card network system 10 having a merchant advice code (MAC) module 28 (broadly, a MAC system). The payment card network system 10 facilitates providing interchange network services, such as an automated billing updater service, offered by an interchange network 16. In addition, the payment card network system 10 enables payment card transactions in which merchants 12, acquirers 14, and/or card issuers 18 do not need to have a one-to-one relationship.

In the example embodiment, the payment card network system 10 generally includes the merchants 12, the acquirers 14, the interchange network 16, and the issuers 18, coupled in communication via a network 20. The network 20 includes, for example and without limitation, one or more of a local area network (LAN), a wide area network (WAN) (e.g., the Internet, etc.), a mobile network, a virtual network, and/or any other suitable public and/or private network capable of facilitating communication among the merchants 12, the acquirers 14, the interchange network 16, and/or the issuers 18. In some embodiments, the network 20 may include more than one type of network, such as a private payment transaction network provided by the interchange network 16 to the acquirers 14 and the issuers 18 and, separately, the public Internet, which may facilitate communication between the merchants 12, the interchange network 16, the acquirers 14, and the consumers 22, etc.

Embodiments described herein may relate to a transaction card system, such as a credit card payment system using the Mastercard® interchange network. (Mastercard is a registered trademark of Mastercard International Incorporated). The Mastercard interchange network is a set of proprietary communications standards promulgated by Mastercard International Incorporated for the exchange of financial transaction data and the settlement of funds between financial institutions that are members of Mastercard International Incorporated. As used herein, financial transaction data includes a unique account number associated with an account holder using a payment card issued by an issuer, purchase data representing a purchase made by the cardholder, including a type of merchant, amount of purchase, date of purchase, and other data, which may be transmitted between any parties of multi-party payment card network system 10.

In a typical transaction card system, a financial institution called the “issuer” issues a transaction card, such as a credit card, to a cardholder or consumer 22, who uses the transaction card to tender payment for a purchase from the merchant 12. In the example embodiment, the merchant 12 is typically associated with products, for example, and without limitation, goods and/or services, that are offered for sale and are sold to the consumers 22. The merchant 12 includes, for example, a physical location and/or a virtual location. A physical location includes, for example, a brick-and-mortar store, etc., and a virtual location includes, for example, an Internet-based store-front.

To accept payment with the transaction card, the merchant 12 must normally establish an account with a financial institution that is part of the payment card network system 10. This financial institution is usually called the “merchant bank,” the “acquiring bank,” or the acquirer 14. When the cardholder 22 tenders payment for a purchase with a transaction card, the merchant 12 requests authorization from the acquirer 14 for the amount of the purchase. The request may be performed over the telephone, but is usually performed through the use of a point-of-sale terminal that reads the cardholder's account information from a magnetic stripe, a chip, or embossed characters on the transaction card and communicates electronically with the transaction processing computers of the acquirer 14. Alternatively, the acquirer 14 may authorize a third party to perform transaction processing on its behalf. In this case, the point-of-sale terminal will be configured to communicate with the third party. Such a third party is usually called a “merchant processor,” an “acquiring processor,” or a “third party processor.”

Using the interchange network 16, computers of the acquirer 14 or merchant processor will communicate with computers of the issuer 18 to determine whether the cardholder's account is in good standing and whether the purchase is covered by the cardholder's available credit line. Based on these determinations, the request for authorization will be declined or accepted. If the request is accepted, an authorization code is issued to the merchant 12.

When a request for authorization is accepted, the available credit line of the cardholder's account is decreased. Normally, a charge for a payment card transaction is not posted immediately to the cardholder's account because bankcard associations, such as Mastercard International Incorporated, have promulgated rules that do not allow the merchant 12 to charge, or “capture,” a transaction until the purchased goods are shipped or the purchased services are delivered. However, with respect to at least some debit card transactions, a charge may be posted at the time of the transaction. When the merchant 12 ships or delivers the goods or services, the merchant 12 captures the transaction by, for example, appropriate data entry procedures on the point-of-sale terminal. This may include bundling of approved transactions daily for standard retail purchases. If the cardholder 22 cancels a transaction before it is captured, a “void” is generated. If the cardholder 22 returns goods after the transaction has been captured, a “credit” is generated. The interchange network 16 and/or the issuer 18 stores the transaction card information, such as, and without limitation, a type of merchant, a merchant identifier, a location where the transaction was completed, an amount of purchase, and a date and time of the transaction, in a transaction database 24.

After a purchase has been made, a clearing process occurs to transfer additional transaction data related to the purchase among the parties to the transaction, such as the acquirer 14, the interchange network 16, and the issuer 18. More specifically, during and/or after the clearing process, additional data, such as a time of purchase, a merchant name, a type of merchant, purchase information, cardholder account information, a type of transaction, itinerary information, information regarding the purchased item and/or service, and/or other suitable information, is associated with a transaction and transmitted between parties to the transaction as transaction data, and may be stored by any of the parties to the transaction.

After a transaction is authorized and cleared, the transaction is settled among the merchant 12, the acquirer 14, and the issuer 18. Settlement refers to the transfer of financial data or funds among the merchant 12, the acquirer 14, and the issuer 18 related to the transaction. Usually, transactions are captured and accumulated into a “batch,” which is settled as a group. More specifically, a transaction is typically settled between the issuer 18 and the interchange network 16, and then between the interchange network 16 and the acquirer 14, and then between the acquirer 14 and the merchant 12.

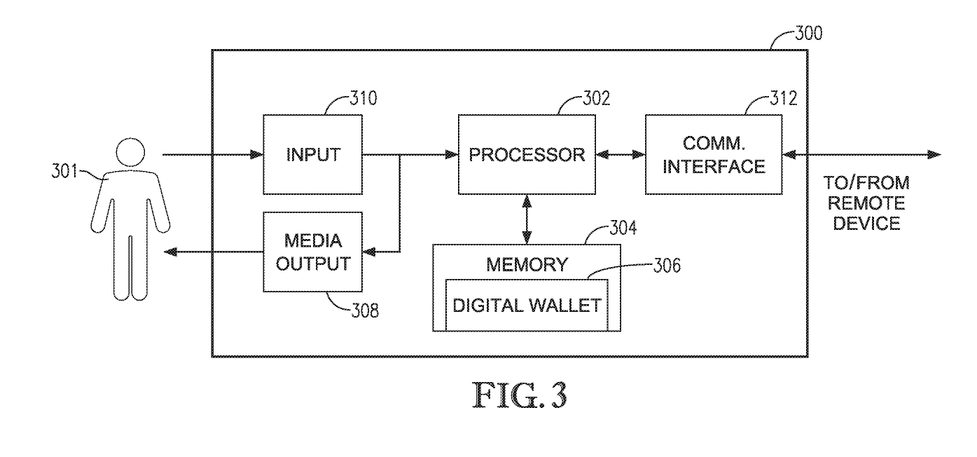

In some embodiments, the payment card transaction is a card-not-present transaction conducted, for example, with a payment card stored as digital wallet data 306 in a digital wallet (shown in FIG. 3). The interchange network 16 includes the MAC module 28 that is configured to analyze various data associated with the payment card transaction and provide various information to one or more parties involved in the payment card transaction, such as the merchant 12 and the acquirer 14. The MAC module 28 is a specially programmed computer system that enables the interchange network 16 to implement an automated process to identify an account number attempting to be authorized, determine if new account information is available for the account number, and provide a “new account information available” indicator in an authorization response message during a payment process. The MAC module 28 is specially programmed with a plurality of algorithms that are configured to extract a primary account number (PAN) from an authorization request message and process the PAN using an ABU database 26 to determine if updated account information is available (e.g., new card or new expiration date). If new account information is available and the authorization response message does not indicate the new account information is available, the algorithms are further configured to populate or inject a “new account information available” indicator into the authorization response message.

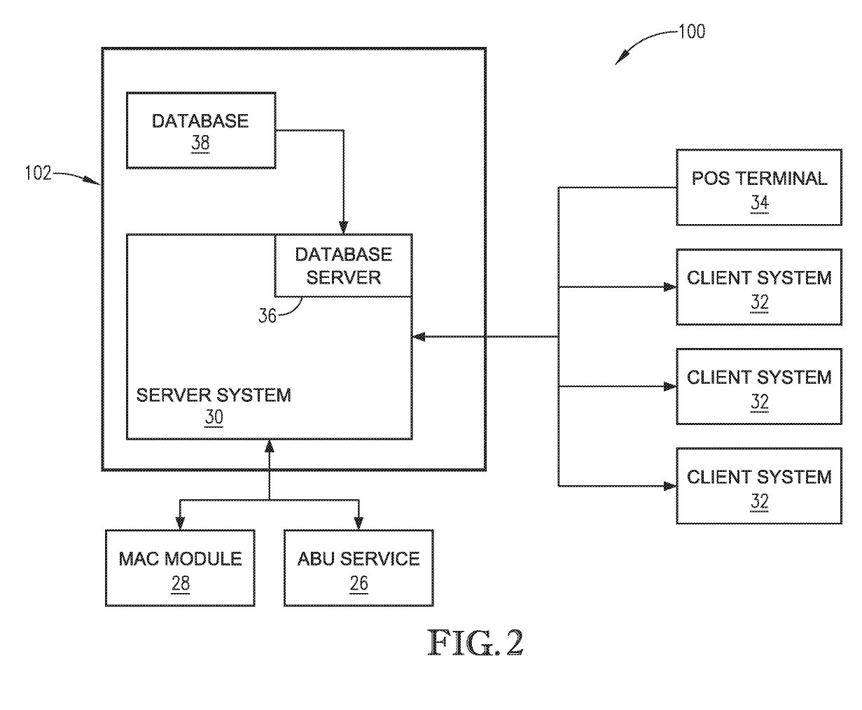

FIG. 2 is a simplified block diagram of an example transaction processing system (TPS) 102 for providing a “new account information available” indicator using the MAC module 28 to merchants 12 and/or merchant acquirers 14 in the payment network 100. In some embodiments, the payment network 100 is similar to the payment card network system 10 (shown in FIG. 1). In the example embodiment, the payment network 100 includes a plurality of computing devices connected in accordance with the present disclosure. The payment network 100 includes a server system 30 of the TPS 102 in communication with a point-of-sale (POS) terminal 34 at a merchant location 12 (shown in FIG. 1), and/or other client systems 32 associated with merchants, merchant banks, payment networks, and/or issuer banks.

More specifically, in the example embodiment, the TPS 102 includes the server system 30 of, for example, the interchange network 16 (shown in FIG. 1), in communication with the POS terminal 34 and the client systems 32 associated with merchants, merchant banks, payment networks, and/or issuer banks. The server system 30 is also in communication with a plurality of client sub-systems, also referred to as the client systems 32. In one embodiment, the client systems 32 are computers including a web browser, such that server system 30 is accessible to the client systems 32 using the Internet. The client systems 32 are interconnected to the Internet through one or more of many interfaces including, for example, a network, such as a LAN or WAN, dial-in-connections, cable modems, and/or special high-speed Integrated Services Digital Network (ISDN) lines. The client systems 32 could be any device capable of interconnecting to the Internet including an Internet connected phone, a PDA, or any other suitable web-based connectable equipment.

In the example embodiment, the TPS 102 also includes one or more POS terminals 34, which may be connected to the client systems 32 and may be connected to the server system 30. The POS terminals 34 may be interconnected to the Internet (or any other network that allows the POS terminals 34 to communicate as described herein) through many interfaces including a network, such as a local area network (LAN) or a wide area network (WAN), dial-in-connections, cable modems, wireless modems, and special high-speed ISDN lines. The POS terminals 34 are any device capable of interconnecting to the Internet and including an input device capable of reading information from a cardholder's financial transaction card. In some embodiments, the POS terminal 34 may be a cardholder's personal computer, such as when conducting an online purchase through the Internet. As used herein, the terms POS device, POS terminal, and point of interaction device are used broadly, generally, and interchangeably to refer to any device in which a cardholder interacts with a merchant to complete a payment card transaction.

A database server 36 is connected to a database 38, which is configured to store information on a variety of matters, including the merchant identification data as described below in greater detail. In one embodiment, the database 38 is a centralized database stored on the server system 30 and can be accessed by potential users at one of the client systems 32 by logging onto the server system 30 through one of the client systems 32. In an alternative embodiment, the database 38 is stored remotely from the server system 30 and may be a distributed or non-centralized database.

In one example embodiment, the database 38 may include a single database having separated sections or partitions or may include multiple databases, each being separate from each other. The database 38 may store transaction data generated as part of sales activities and savings activities conducted over the processing network including data relating to merchants, account holders or customers, issuers, acquirers, savings amounts, savings account information, and/or purchases made. The database 38 may also store account data including at least one of a cardholder name, a cardholder address, an account number, and other account identifier. The database 38 may also store merchant data including a merchant identifier that identifies each merchant registered to use the network, and instructions for settling transactions including merchant bank account information. The database 38 may also store purchase data associated with items being purchased by a cardholder from a merchant, and authorization request data. The database 38 may also store digital wallet data 306, device information, payment card information, and other data involved with providing “new account information available” indicators to one or more parties to the transaction.

In the example embodiment, one of the client systems 32 may be associated with the acquirer 14 (shown in FIG. 1) while another one of the client systems 32 may be associated with the issuer 18 (shown in FIG. 1). The POS terminal 34 may be associated with the merchant 12 (shown in FIG. 1) or may be a computer system and/or mobile system used by a cardholder making an on-line purchase or payment. The server system 30 may be associated with the interchange network 16 or a payment processor. In the example embodiment, the server system 30 is associated with a financial transaction processing network, such as the interchange network 16, and may be referred to as an interchange computer system. The server system 30 may be used for processing transaction data. In addition, the client systems 32 and the POS terminal 34 may include a computer system associated with at least one of a merchant, an online bank, a bill payment outsourcer, an acquirer bank, an acquirer processor, an issuer bank associated with a transaction card, an issuer processor, a remote payment processing system, and/or a biller.

In the example embodiment, the TPS 102 is in communication with the MAC module 28 and the ABU database 26, which may be associated with the interchange network 16 or with an outside third party in a contractual relationship with the interchange network 16. In some embodiments, the MAC module 28 and the ABU database 26 are in communication with each other and may directly interact during the processing of payment card transactions. In the example embodiment, the MAC module 28 extracts PANs from payment transactions and inserts merchant advice codes in response messages of the payment transactions, and the ABU database 26 provides additional and/or updated account information corresponding to the account associated with the payment transaction. In some embodiments, the MAC module 28 and/or the ABU database 26 are also in communication with a merchant system and/or an issuer system (e.g., the client systems 32) and/or the POS terminal 34 of the merchant. It is noted that the payment network 100 may include more, fewer, or alternative components and/or perform more, fewer, or alternative actions, including those discussed elsewhere herein.

FIG. 3 is an example configuration of a user system 300 operated by a user 301, such as the cardholder 22 (shown in FIG. 1). In some embodiments, the user system 300 is a client system 32 and/or a merchant POS terminal 34. In the example embodiment, the user system 300 includes a processor 302 for executing instructions. In some embodiments, executable instructions are stored in a memory device 304. The processor 302 includes one or more processing units, for example, a multi-core configuration. The memory device 304 is any device allowing information such as the digital wallet data 306, executable instructions, and/or written works to be stored and retrieved. The memory device 304 includes one or more computer readable media.

The user system 300 also includes at least one media output component 308 for presenting information to the user 301. The media output component 308 is any component capable of conveying information to the user 301. In some embodiments, the media output component 308 includes an output adapter such as a video adapter and/or an audio adapter. An output adapter is operatively coupled to the processor 302 and operatively connectable to an output device such as a display device, a liquid crystal display (LCD), organic light emitting diode (OLED) display, or “electronic ink” display, or an audio output device, a speaker, or headphones.

In some embodiments, the user system 300 includes an input device 310 for receiving input from the user 301. The input device 310 may include, for example, a touch sensitive panel, a touch pad, a touch screen, a stylus, a gyroscope, an accelerometer, a position detector, a keyboard, a pointing device, a mouse, or an audio input device. A single component such as a touch screen may function as both an output device of the media output component 308 and the input device 310. The user system 300 may also include a communication interface 312, which is communicatively connectable to a remote device such as the server system 30 and/or the POS terminal 32 (shown in FIG. 2). The communication interface 312 may include, for example, a wired or wireless network adapter or a wireless data transceiver for use with Bluetooth communication, radio frequency communication, near field communication (NFC), and/or with a mobile phone network, Global System for Mobile communications (GSM), 3G, or other mobile data network, and/or Worldwide Interoperability for Microwave Access (WiMax) and the like.

Stored in the memory device 304 are, for example, computer readable instructions for providing a user interface to the user 301 via the media output component 308 and, optionally, receiving and processing input from the input device 310. A user interface may include, among other possibilities, a web browser and a client application. Web browsers enable users, such as the user 301, to display and interact with media and other information typically embedded on a web page or a website from the server system 30. A client application allows the user 301 to interact with a server application from the server system 30.

In the example embodiment, the computing device 300 is a user computing device from which the user 301 engages with a digital wallet 306, an online merchant (e.g., the merchant 12 shown in FIG. 1), an interchange network (e.g., the interchange network 16 shown in FIG. 1), and an issuer of a payment card (e.g., the issuer 18 shown in FIG. 1) to perform a payment transaction that undergoes a merchant advice code population process.

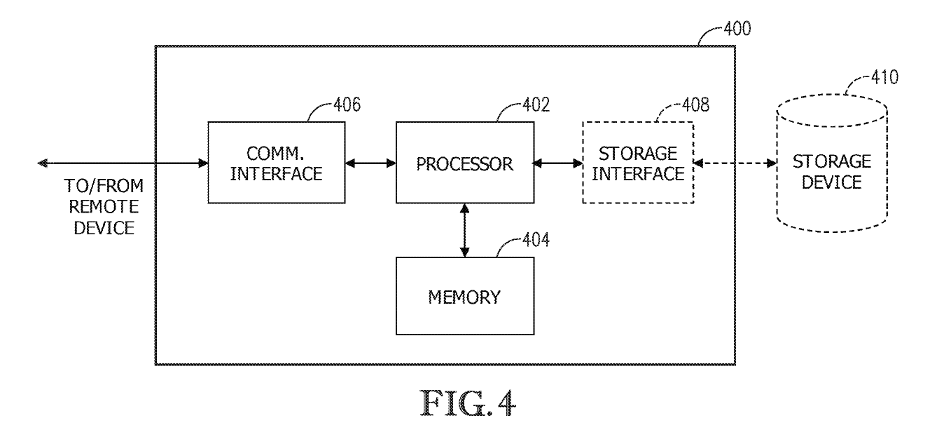

FIG. 4 is an example configuration of a server system 400, such as the server system 30 (shown in FIG. 2). The server system 400 includes, but is not limited to, the transaction database 24 (shown in FIG. 1), the MAC module 28, and/or the ABU database 26. In the example embodiment, the server system 400 includes a processor 402 for executing instructions. The instructions may be stored in a memory area 404, for example. The processor 402 includes one or more processing units (e.g., in a multi-core configuration) for executing the instructions. The instructions may be executed within a variety of different operating systems on the server system 400, such as UNIX, LINUX, Microsoft Windows®, etc. More specifically, the instructions may cause various data manipulations on data stored in a storage device 410 (e.g., create, read, update, and delete procedures). It should also be appreciated that upon initiation of a computer-based method, various instructions may be executed during initialization. Some operations may be required to perform one or more processes described herein, while other operations may be more general and/or specific to a programming language (e.g., C, C#, C++, Java, or other suitable programming languages, etc.).

The processor 402 is operatively coupled to a communication interface 406 such that the server system 400 can communicate with a remote device such as a user system 300 (shown in FIG. 3) or another server system 400. For example, the communication interface 406 may receive communications from a client system 32 via the Internet, as illustrated in FIG. 2.

The processor 402 is operatively coupled to the storage device 410. The storage device 410 is any computer-operated hardware suitable for storing and/or retrieving data. In some embodiments, the storage device 410 is integrated in the server system 400. In other embodiments, the storage device 410 is external to the server system 400 and is similar to the transaction database 24. For example, the server system 400 may include one or more hard disk drives as the storage device 410. In other embodiments, the storage device 410 is external to the server system 400 and may be accessed by a plurality of server systems 400. For example, the storage device 410 may include multiple storage units such as hard disks or solid-state disks in a redundant array of inexpensive disks (RAID) configuration. The storage device 410 may include a storage area network (SAN) and/or a network attached storage (NAS) system.

In some embodiments, the processor 402 is operatively coupled to the storage device 410 via a storage interface 408. The storage interface 408 is any component capable of providing the processor 402 with access to the storage device 410. The storage interface 408 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 402 with access to the storage device 410.

The memory area 404 includes, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

In the example embodiment, server system 400 is a merchant advice code processing system in communication with one or more of the issuer 18 and the merchant 12 during a payment card transaction involving a digital wallet 306 (shown in FIG. 3) of a user, such as cardholder 22 (shown in FIG. 1). The server system 400 checks for account information updates for accounts initiating a payment transaction and provides updated account information indicators to a merchant associated with the payment transaction.

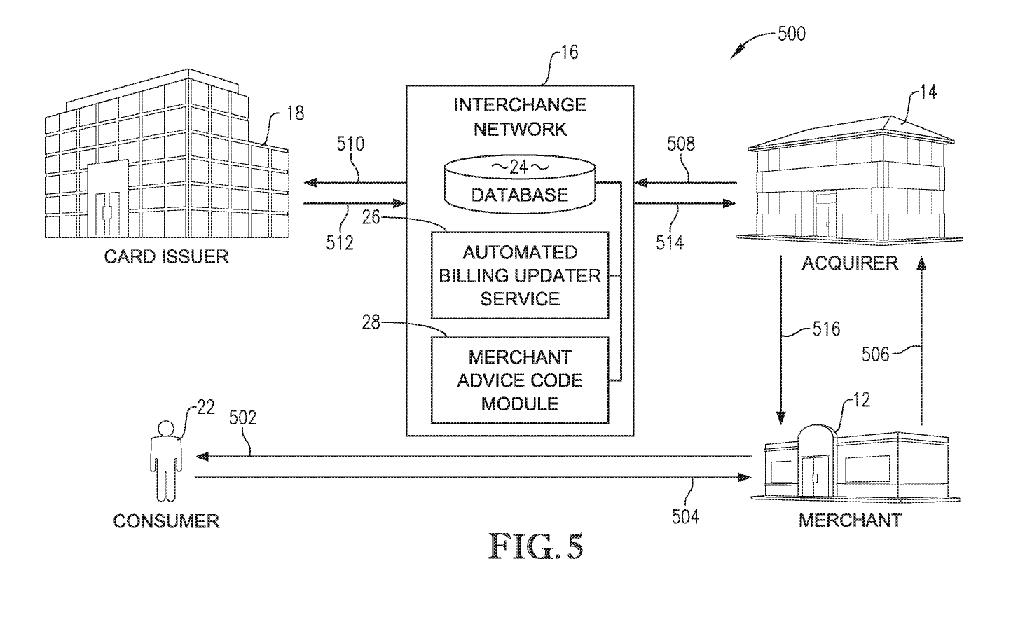

FIG. 5 is a schematic diagram of the payment card network system 10 showing data flow among the parties during a payment transaction. In the example embodiment, the payment transaction is a card-not-present transaction. The cardholder 22 initiates the payment transaction using for example, and without limitation, a computing device containing a digital wallet, such as the user system 300 (shown in FIG. 3) to electronically transact with the merchant 12 to purchase goods and/or services.

In the example embodiment, the merchant 12 includes a merchant computer device, such as the POS terminal 34 (shown in FIG. 2). When the cardholder 22 selects to initiate a transaction with the merchant 12, the merchant 12 transmits purchase data 502, for example, and without limitation, by the Internet or by radio transmission to the user's computing device. The purchase data 502 includes information related to goods and/or services provided by the merchant 12. For example, and without limitation, in one embodiment, the merchant 12 is associated with a fitness center and the purchase data 502 is product or service information such as, for example, a recurring membership fee to the fitness center. The cardholder 22 transmits the transaction data 504 to the merchant 12 after receiving the purchase data 502 from the merchant 12. The cardholder 22 may transmit the transaction data 504 wirelessly via user's computing device to the merchant 12, i.e., to the POS terminal 34. The transaction data 504 includes transaction information responsive to the purchase data 502, i.e., the transaction data 504 indicates a purchased item identifier associated with the goods and/or services the cardholder 22 would like to purchase from the merchant 12 and a payment credential (i.e., the digital wallet data 306 shown in FIG. 3).

The merchant 12 receives the transaction data 504 and generates a payment authorization request message 506. It is noted that the messages within an interchange network such the interchange network 16, may, in at least some instances, conform to the International Organization for Standardization (ISO) Standard 8583, Financial transaction card originated messages—Interchange message specifications, which is the ISO standard for systems that exchange electronic transactions made by cardholders using payment cards. In the example embodiment, the payment authorization request message 506 can be an ISO 8583 message type identifier (MTI) “0100” message.

The payment authorization request message 506 (i.e., the “0100” message) is transmitted to the acquirer 14 for processing and further transmitted to the issuer 18 for approval. For example, the acquirer 14 communicates with and transmits the “0100” message to the interchange network 16, as indicated by arrow 508. The interchange network 16 may check the PAN associated with the “0100” message against the ABU database 26, as is described herein, to determine whether new or updated account information is available. If new account information is available, the interchange network 16 stores a “new account information available” indicator in memory, such as the database 38, and waits to receive a payment authorization response message from the issuer 18. The interchange network 16 forwards the “0100” message to the issuer 18, as indicated by arrow 510 to determine whether the cardholder 22 is authorized to make the transaction.

The issuer 18 transmits a payment authorization response message 512 back to the interchange network 16 after approval or disapproval of the authorization request (i.e., the “0100” message). In the example embodiment, the payment authorization response message 512 can be an ISO 8583 message type identifier (MTI) “0110” message. If the issuer 18 disapproves or denies the transaction, the issuer may populate the merchant advice code portion of the payment authorization response message 512 with information as to why the transaction was disapproved. For example, if the account and/or payment card used by the cardholder 22 has been issued a new account number or expiration date, the payment may be declined because the authorization request is against the old account data. The issuer may provide an indicator in the “0110” response message that new account information is available. This may enable the merchant 12 to request updated account information from the cardholder 22 and/or the interchange network 16 via the automated billing updater service.

If the “0110” response message from the issuer does not have the merchant advice code populated by the issuer 18 and the interchange network 16 has determined that new account information is available, the interchange network may inject or populate the merchant advice code with the indicator stored in memory. The interchange network 16 then transmits the edited “0110” payment authorization response message to the acquirer 14, as indicated by arrow 514. The acquirer transmits the edited “0110” payment authorization response message to the merchant 12, as indicated by arrow 516. In the example embodiment, the merchant 12 thereafter cancels the transaction based upon the disapproval response to the authorization request.

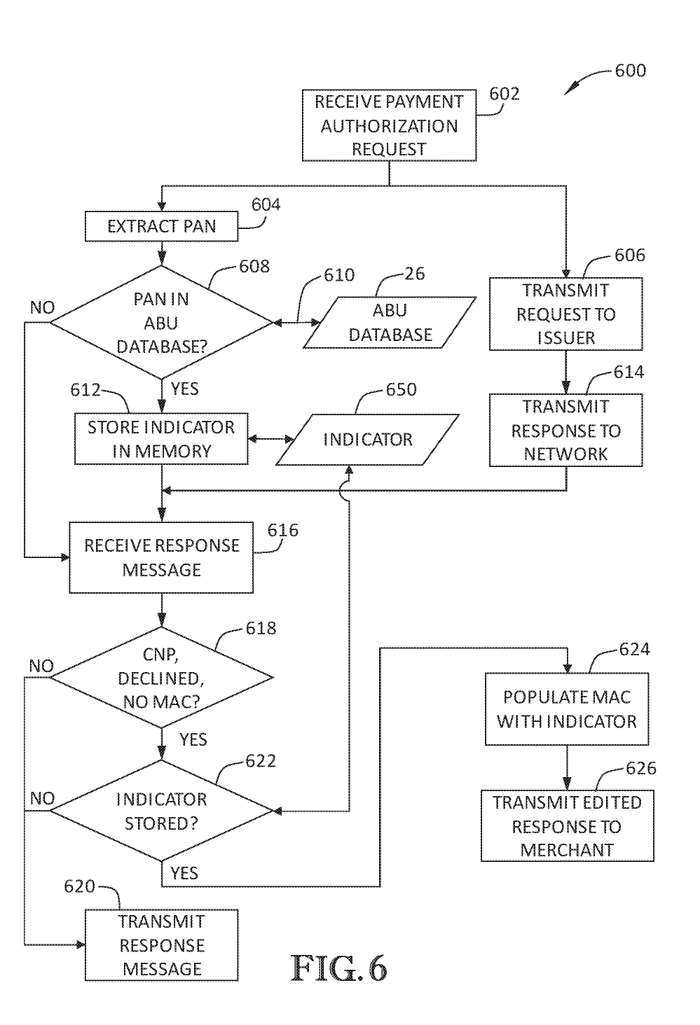

FIG. 6 shows a flow chart of an example method 600 for populating a merchant advice code in a payment authorization response message (shown in FIG. 5). In the example embodiment, the method 600 is implemented by the MAC module 28 (shown in FIG. 1). The method 600 is a computer-implemented method for extracting a PAN from a payment authorization request message, determining whether the PAN has new or updated account information available, and populating the merchant advice code of a payment authorization response message.

In the example method 600, an operation 602 includes receiving a payment authorization request message, such as the payment authorization request message 506 (shown in FIG. 5). The payment authorization request message 506 is submitted by the merchant 12 (shown in FIG. 1) to the merchant bank or acquirer 14 (shown in FIG. 1). The acquirer 14 forwards the payment authorization request message 506 along, where it is received by the interchange network 16 (shown in FIG. 1). The method 600 includes an operation 604 wherein the interchange network extracts a PAN from the payment authorization request message 506. Specifically, the MAC module 28 extracts a copy of the PAN from the payment authorization request message 506 and temporarily stores it in memory, such as memory 404 (shown in FIG. 4). At operation 606, the interchange network 16 transmits the payment authorization request message 506 to the issuer 18 for processing.

At an operation 608, the interchange network 16 determines whether the PAN exists in the ABU database 26. This step is indicated at 610, and is accomplished by accessing the ABU database 26 and comparing the PAN to the data entries therein. If no entry corresponding to the PAN is found, then the PAN does not have any new account information associated with it, and the method 600 continues at operation 616, described herein. If an entry corresponding to the PAN is found, then the PAN has new account information associated with it. New account information may include, for example, an updated expiration date, a new account number, etc. At operation 612, the interchange network 16, and more specifically, the MAC module 28, stores an indicator 650 in memory. The indicator 650 includes, for example, an indicator code “01” that indicates that new account information is available. The indicator is injected into the merchant advice code of a response message as described below.

At operation 614, the issuer transmits a payment authorization response message 512 (shown in FIG. 5) to the interchange network 16. At operation 616, the interchange network receives the payment authorization response message 512 from the issuer 18. From the payment authorization response message 512, the interchange network determines, at operation 618, whether the transaction is declined, whether the transaction is a card-not-present transaction, and whether the issuer populated the merchant advice code. If all three criteria are not met (i.e., the transaction is not declined (e.g., it is approved), the transaction is not a card-not-present transaction (e.g., it is a card present transaction), or the issuer populated the merchant advice code), the interchange network 16 passes the payment authorization response message 512 unchanged, via the acquirer 14 or otherwise, to the merchant at operation 620. If the payment authorization response message 512 indicates that the transaction is declined, that the transaction is a card-not-present transaction, and that the merchant advice code is not populated by the issuer 18, the interchange network 16 checks the memory for the indicator 650 at operation 622. If there is no indicator 650 stored in the memory, the interchange network 16 passes the payment authorization response message 512 unchanged to the merchant at operation 620. If the memory includes the indicator 650, then the PAN has updated account information. At operation 624, the interchange network, and more particularly, the MAC module 28, edits the payment authorization response message 512 to inject or populate the merchant advice code with the indicator 650. Specifically, in the example embodiment, the MAC module 28 injects a value of “01” (New account information available) in DE 48 (Additional Data—Private Use), sub-element 84 (Merchant Advice Code) of the payment authorization response message 512. At operation 626, the edited or updated payment authorization response message 516 (shown in FIG. 5) is transmitted to the merchant 12, via the acquirer 14 or otherwise, and the merchant 12 may request updated the updated account information from the interchange network 16.

Any actions, functions, operations, and the like recited herein may be performed in the order shown in the figures and/or described above, or may be performed in a different order. Furthermore, some operations may be performed concurrently as opposed to sequentially. Although the computer-implemented method is described above, for the purpose of illustration, as being executed by an example system and/or example physical elements, it will be understood that the performance of any one or more of such actions may be differently distributed without departing from the spirit of the present invention.

A computer-readable storage media or medium comprising a non-transitory medium may include an executable computer program stored thereon and for instructing one or more processing elements to perform some or all of the operations described herein, including some or all of the operations of the computer-implemented method. The computer program stored on the computer-readable medium may instruct the processor and/or other components of the system to perform additional, fewer, or alternative operations, including those discussed elsewhere herein.

All terms used herein are to be broadly interpreted unless otherwise stated. For example, the term “payment card” and the like may, unless otherwise stated, broadly refer to substantially any suitable transaction card, such as a credit card, a debit card, a prepaid card, a charge card, a membership card, a promotional card, a frequent flyer card, an identification card, a prepaid card, a gift card, and/or any other device that may hold payment account information, such as mobile phones, Smartphones, personal digital assistants (PDAs), key fobs, and/or computers. Each type of transaction card can be used as a method of payment for performing a transaction.

The terms “processor,” “processing element,” and the like, as used herein, may, unless otherwise stated, broadly refer to any programmable system including systems using central processing units, microprocessors, microcontrollers, reduced instruction set circuits (RISC), application specific integrated circuits (ASIC), logic circuits, and any other circuit or processor capable of executing the functions described herein. The above examples are example only, and are thus not intended to limit in any way the definition and/or meaning of the term “processor.” In particular, a “processor” may include one or more processors individually or collectively performing the described operations. In addition, the terms “software,” “computer program,” and the like, may, unless otherwise stated, broadly refer to any executable code stored in memory for execution on mobile devices, clusters, personal computers, workstations, clients, servers, and a processor or wherein the memory includes read-only memory (ROM), electronic programmable read-only memory (EPROM), random access memory (RAM), erasable electronic programmable read-only memory (EEPROM), and non-volatile RAM (NVRAM) memory. The above memory types are example only, and are thus not limiting as to the types of memory usable for storage of a computer program.

The terms “computer,” “computing device,” “computer system,” and the like, as used herein, may, unless otherwise stated, broadly refer to substantially any suitable technology for processing information, including executing software, and may not be limited to integrated circuits referred to in the art as a computer, but may broadly refer to a microcontroller, a microcomputer, a programmable logic controller (PLC), an application specific integrated circuit, and other programmable circuits, and these terms are used interchangeably herein.

The term “network,” “communications network,” and the like, as used herein, may, unless otherwise stated, broadly refer to substantially any suitable technology for facilitating communications (e.g., GSM, CDMA, TDMA, WCDMA, LTE, EDGE, OFDM, GPRS, EV-DO, UWB, WiFi, IEEE 802 including Ethernet, WiMAX, and/or others), including various local area networks (LANs), personal area networks (PAN), or short-range communications protocols.

The term “communication component,” “communication interface,” and the like, as used herein, may, unless otherwise stated, broadly refer to substantially any suitable technology for facilitating communications, and may include one or more transceivers (e.g., WWAN, WLAN, and/or WPAN transceivers) functioning in accordance with IEEE standards, 3GPP standards, or other standards, and configured to receive and transmit signals via a communications network.

The term “memory area,” “storage device,” and the like, as used herein, may, unless otherwise stated, broadly refer to substantially any suitable technology for storing information, and may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others.

Although the invention has been described with reference to the one or more embodiments illustrated in the figures, it is understood that equivalents may be employed and substitutions made herein without departing from the scope of the invention as recited in the claims.

Having thus described one or more embodiments of the invention, what is claimed as new and desired to be protected by Letters Patent includes the following:

What is claimed is:

1. A merchant advice code system for populating a merchant advice code in a payment authorization response message of a payment transaction, said merchant advice code system comprising:
a memory device for storing data; and
a processor communicatively coupled to said memory device, said processor programmed to:
receive a payment authorization request message including a primary account number relating to the payment account of a cardholder;
extract a copy of the primary account number from the payment authorization request message;
determine whether the primary account number exists in an automated billing service database;
in response to determining that the primary account number exists in the automated billing service database, store an indicator in the memory device; and
populate the merchant advice code in the payment authorization response message with the indicator, thereby generating an edited payment authorization response message.

2. The merchant advice code system in accordance with claim 1,
said processor programmed to transmit the payment authorization request message to an issuer.

3. The merchant advice code system in accordance with claim 1,
said processor, in determining whether the primary account number exists in the automated billing service database, programmed to:
access the automated billing service database;
compare the primary account number to data entries therein; and
identify an entry corresponding to the primary account number.

4. The merchant advice code system in accordance with claim 1,
said processor programmed to receive the payment authorization response message from an issuer.

5. The merchant advice code system in accordance with claim 1,
said processor programmed to determine from the payment authorization response message each the following: whether the transaction is declined, whether the transaction is a card-not-present transaction, and whether the issuer did not populate the merchant advice code.

6. The merchant advice code system in accordance with claim 5,
said processor programmed to, in response to determining at least one of that (i) the transaction is not declined, (ii) the transaction is not a card-not-present transaction, or (iii) the issuer populated the merchant advice code, transmit the payment authorization response message to an acquirer.

7. The merchant advice code system in accordance with claim 5,
said processor programmed to, in response to determining each of that (i) the transaction is declined, (ii) the transaction is a card-not-present transaction, and (iii) the issuer did not populate the merchant advice code, transmit the edited payment authorization response message to an acquirer.

8. The merchant advice code system in accordance with claim 1,
said processor programmed to, in response to determining that the primary account number does not exist in the automated billing service database, transmit the payment authorization response message to an acquirer.

9. The merchant advice code system in accordance with claim 1,
said processor programmed to transmit the edited payment authorization response message to an acquirer.

10. A computer-implemented method for populating a merchant advice code in a payment authorization response message, said method comprising:
receiving a payment authorization request message including a primary account number relating to the payment account of a cardholder;
extracting a copy of the primary account number from the payment authorization request message;
determining whether the primary account number exists in an automated billing service database;
in response to determining that the primary account number exists in the automated billing service database, storing an indicator in a memory device; and
populating the merchant advice code in the payment authorization response message with the indicator, thereby generating an edited payment authorization response message.

11. The method in accordance with claim 10, further comprising:
transmitting the payment authorization request message to an issuer.

12. The method in accordance with claim 10, wherein said determining operation comprises the operations of—
accessing the automated billing service database,
comparing the primary account number to data entries therein, and
identifying an entry corresponding to the primary account number.

13. The method in accordance with claim 10, further comprising:
receiving the payment authorization response message from an issuer.

14. The method in accordance with claim 10, further comprising:
determining from the payment authorization response message each the following: whether the transaction is declined, whether the transaction is a card-not-present transaction, and whether the issuer did not populate the merchant advice code.

15. The method in accordance with claim 14, further comprising:
in response to determining at least one of that (i) the transaction is not declined, (ii) the transaction is not a card-not-present transaction, or (iii) the issuer populated the merchant advice code, transmitting the payment authorization response message to an acquirer.

16. The method in accordance with claim 14, further comprising:
in response to determining each of that (i) the transaction is declined, (ii) the transaction is a card-not-present transaction, and (iii) the issuer did not populate the merchant advice code, transmitting the edited payment authorization response message to an acquirer.

17. The method in accordance with claim 10, further comprising:
in response to determining that the primary account number does not exist in the automated billing service database, transmitting the payment authorization response message to an acquirer.

18. One or more non-transitory computer-readable storage media having computer-executable instructions embodied thereon, wherein when executed by at least one processor, the computer-executable instructions cause the processor to:
receive a payment authorization request message including a primary account number relating to the payment account of a cardholder;
extract a copy of the primary account number from the payment authorization request message;
determine whether the primary account number exists in an automated billing service database;
in response to determining that the primary account number exists in the automated billing service database, store an indicator in the memory device; and
populate a merchant advice code in a payment authorization response message with the indicator, generating an edited payment authorization response message.

19. The computer-readable storage media in accordance with claim 18 wherein the computer-executable instructions further cause the processor to:
receive the payment authorization response message from an issuer.

20. The computer-readable storage media in accordance with claim 18 wherein the computer-executable instructions further cause the processor to:
determine from the payment authorization response message each the following: whether the transaction is declined; whether the transaction is a card-not-present transaction, and whether the issuer did not populate the merchant advice code.
